(19) United States
(12) Patent Application Publication
(10) Pub. No.: US 2004/0049505 A1
(43) Pub. Date: Mar. 11, 2004

(54) Textual on-line analytical processing method and system

(76) Inventor: Kelly Pennock, Bothell, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/241,981

(22) Filed: Sep. 11, 2002

(51) Int. Cl. G06F 7/00

(52) U.S. Cl. 707/5

(57) ABSTRACT

The present invention provides for a system and method that allows OLAP analysis of unstructured content. This is accomplished by transforming isolated, unstructured content into quantifiable structured data, thereby creating a common measure for performing OLAP analysis. This allows the seamless integration of unstructured content with structured data sources. It also allows for the ability to query what was before unqueriable information that enterprises were in possession of.

### FIELD OF THE INVENTION

The present invention relates generally to an information processing system, and more particularly, to a computing system for performing on-line analytical processing on unstructured data.

### BACKGROUND OF THE INVENTION

As companies increasingly create and store large amounts of information in electronic form, computer databases and electronic files play an increasingly important role in everyday business operations. For any particular database, users or system administrators will generally have created a variety of preformatted queries that can be used to extract information from that database. Each query may specify a particular group of information in a database, and when the query is executed on the database, a response is generated containing information extracted from the database. Despite the availability of preformatted queries, the actual process of extracting desired information from databases can be cumbersome. As companies grow and have more databases that must be accessed, this process of extracting desired information becomes even more cumbersome.

Relational DataBase Management System (“RDBMS”) software using a Structured Query Language (“SQL”) interface is well known in the art, and the SQL interface has evolved into a standard language for RDBMS software. RDBMS software has typically been used with databases comprised of traditional data types that are easily structured into tables. However, RDBMS products do have limitations with respect to providing users with specific views of data. Thus, “front-ends” have been developed for RDBMS products so that data retrieved from the RDBMS can be aggregated, summarized, consolidated, summed, viewed, and analyzed. However, even these “front-ends” do not easily provide the ability to consolidate, view, and analyze data in the manner of “multi-dimensional data analysis.” This type of functionality is also known as on-line analytical processing (“OLAP”).

Online Analytical Processing, or OLAP, is a process or methodology related to the timely analysis of data, typically business data, for decision making. OLAP provides a multidimensional view of data, including full support for hierarchies and multiple hierarchies. OLAP is therefore aimed at decision support, distinguishing it from transaction oriented database systems for Online Transaction Processing, or “OLTP,” which are designed primarily to record recurring activities in the enterprise such as sales or receipt of goods. It is this decision oriented nature that establishes the fundamental requirements of an OLAP system.

A number of requirements distinguish OLAP from OLTP technologies. OLAP systems are multi-dimensional in nature, implying the ability to structure multiple dimensions or views in a hierarchical organization. OLAP also embeds often expensive analysis, since supporting good decisions means aggregating and analyzing large quantities of data as part of standard OLAP operations such as drill-down and aggregation. Much of the complexity of this analysis is hidden from user view since it has been pre-computed for presentation in the OLAP interface. Flexibility is another characteristic important to OLAP systems: flexibility in operations, measures, querying, viewing, and more is essential to permit users to understand issues from multiple angles. Speed of access is yet another essential element for OLAP, a characteristic that underlies the previously mentioned characteristics. Since the fundamental operation is data access, and since the date is large in volume and potentially complex, efficiency is central to any OLAP implementation—implementations that are not fast will not support timely decision making.

Data consolidation is the process of synthesizing data into essential knowledge. The highest level in a data consolidation path is referred to as that data's dimension. A given data dimension represents a specific perspective of the data included in its associated consolidation path. There are typically a number of different dimensions from which a given pool of data can be analyzed. This plural perspective, or Multi-Dimensional Conceptual View, appears to be the way most business persons naturally view their enterprise. Each of these perspectives is considered to be a complementary data dimension. Simultaneous analysis of multiple data dimensions is referred to as multi-dimensional data analysis.

OLAP functionality is characterized by dynamic multi-dimensional analysis of consolidated data supporting end user analytical and navigational activities including:

calculations and modeling applied across dimensions, through hierarchies and/or across members;

trend analysis over sequential time periods;

slicing subsets for on-screen viewing;

drill-down to deeper levels of consolidation;

reach-through to underlying detail data; and

rotation to new dimensional comparisons in the viewing area.

OLAP is often implemented in a multi-user client/server mode and attempts to offer consistently rapid response to database access, regardless of database size and complexity.

OLAP systems are sometimes implemented by moving data into specialized databases (“OLAP cubes”), which are optimized for providing OLAP functionality. In many cases, the receiving data storage is multidimensional in design (“MOLAP”). Another approach is to directly query data in relational databases in order to facilitate OLAP (“ROLAP”). A still further approach combines MOLAP and ROLAP to form a hybrid (“HOLAP”).

All of the above systems assume that information is already in structured form (e.g., a document or document components have already been broken down and/or categorized). Usually, if documents are not stored in a structured form, information, such as key words or concepts, has been gathered on a per document basis using a search engine. Present search engines such as Google, Excite, and Alta Vista perform these following common functions:

browsing of the documents by a program or system of programs to identify content and attributes;

parsing of the documents to separate out words, information, and attributes;

indexing some or all of the words, information, and attributes of the documents into a database;

querying the index and database through a user interface;

maintaining the information, words, and attributes in an index and database through data movement and management programs, as well as re-scanning the systems for documents, looking for changed documents, deleted documents, added documents, moved documents and new systems, files, information, connections to other systems and any other data and information.

As is readily apparent, the search engine tools cannot provide the same level of analysis that the OLAP tools can. Therefore, it would be desirable to use the powerful OLAP tools for unstructured content. Still further, it would be desirable to have such an OLAP system that performs such OLAP analysis in an efficient manner.

### SUMMARY OF THE INVENTION

In one aspect of the present invention, the processing of unstructured documents to form a structured dimension suitable for on-line analytical processing is accomplished by first selecting a subcollection of documents of common interest, computing comparable document representations for all unstructured documents in the subcollection, organizing documents according to these representations in a hierarchical manner, and updating a data structure for on-line analytical processing of the hierarchically arranged documents. The document representations are formed by examining features of interest in the unstructured documents and then computing a representation based on these features. While a number of different meaningful representations of the documents may be used, one form of representation would be document vectors that characterize the documents. By organizing the documents in hierarchical clusters based on document vectors, it is then possible to use some of the OLAP analysis tools such as roll-up, drill-down, and other conventional on-line analytical processing tools that are usually only available to structured data. The process described for creating a single dimension can be repeated indefinitely to provide multiple dimensions for multi-dimensional analysis. In a second aspect of this invention, measures for unstructured documents are computed by examining numerous features associated with the measures and quantifying the importance and degree of those features in each document, thereby transforming unstructured documents into quantities that can be manipulated by standard OLAP operators.

As will be readily appreciated from the foregoing summary, the invention provides a new and improved method of transforming unstructured content into structured content for on-line analytical processing in a way that enables the formerly unstructured content to be processed for information retrieval purposes, and a related system and computer-readable medium.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of a suitable computer system environment in accordance with the present invention.

FIG. 2 is an overview flow diagram illustrating processing unstructured content to form OLAP data.

FIG. 3 is an overview flow diagram illustrating a subroutine for computing document representations.

FIG. 4 is an overview flow diagram illustrating a subroutine for organizing unstructured content into a structured OLAP searchable form.

FIG. 5 is a simplified clustered hierarchy used to form an OLAP data structure in accordance with the present invention.

FIG. 6 is an exemplary view of a sample data structure presenting measures and values of dimensions from OLAP data.

FIG. 7 is an overview flow diagram illustrating querying an OLAP data structure (and optionally external data) in accordance with the present invention.

FIG. 8 is an exemplary screenshot of OLAP query results in accordance with the present invention.

### DETAILED DESCRIPTION OF THE PREFERRED EMBODIMENT

In the following detailed description, reference is made to the accompanying drawings which form a part hereof and which illustrate specific exemplary embodiments in which the invention may be practiced. These embodiments are described in sufficient detail to enable those skilled in the art to practice the invention, and it is to be understood that other embodiments may be utilized and that logical, mechanical, electrical, and other changes may be made without departing from the scope of the present invention. The following detailed description is, therefore, not to be taken in a limiting sense, and the scope of the present invention is defined only by the appended claims.

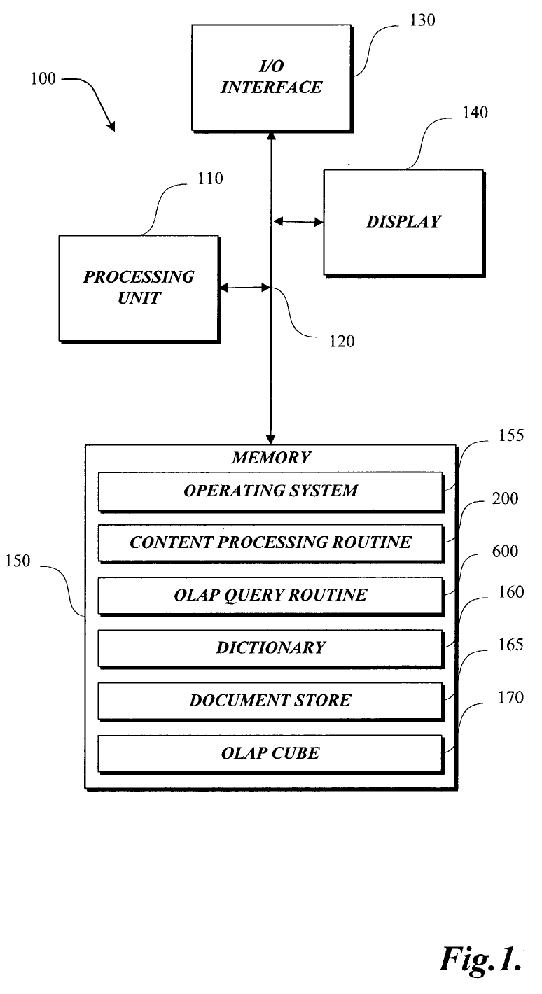

FIG. 1 depicts several of the key components of a computing device 100. Those of ordinary skill in the art will appreciate that the computing device 100 may include many more components than those shown in FIG. 1. However, it is not necessary that all of these generally conventional components be shown in order to disclose an enabling embodiment for practicing the present invention. As shown in FIG. 1, the computing device 100 includes an input/output (“I/O”) interface 130 for connecting to other devices (not shown). Those of ordinary skill in the art will appreciate that the I/O interface 130 includes the necessary circuitry for such a connection, and is also constructed for use with the necessary protocols.

The computing device 100 also includes a processing unit 110, a display 140, and a memory 150 all interconnected along with the I/O interface 130 via a bus 120. The memory 150 generally comprises a random access memory (“RAM”), a read-only memory (“ROM”), and a permanent mass storage device, such as a disk drive, tape drive, optical drive, floppy disk drive, or combination thereof. The memory 150 stores an operating system 155, a content processing routine 200, an OLAP query routine 600, a dictionary 110, a document store 165 for holding a corpus of unstructured documents, and an OLAP cube 170 for holding structured document information. OLAP cubes, such as cube 170 comprise a cache of hierarchies of values, and in the present invention these hierarchies comprise document representations as will be described below. It will be appreciated that these software components may be loaded from a computer-readable medium into memory 150 of the computing device 100 using a drive mechanism (not shown) associated with the computer readable medium, such as a floppy, tape, or DVD/CD-ROM drive, or via the I/O interface 130.

Although an exemplary computing device 100 has been described that generally conforms to a conventional general purpose computing device, those of ordinary skill in the art will appreciate that a computing device 100 may be any of a great number of devices capable of processing content for OLAP purposes including, but not limited to, database servers configured for OLAP information retrieval.

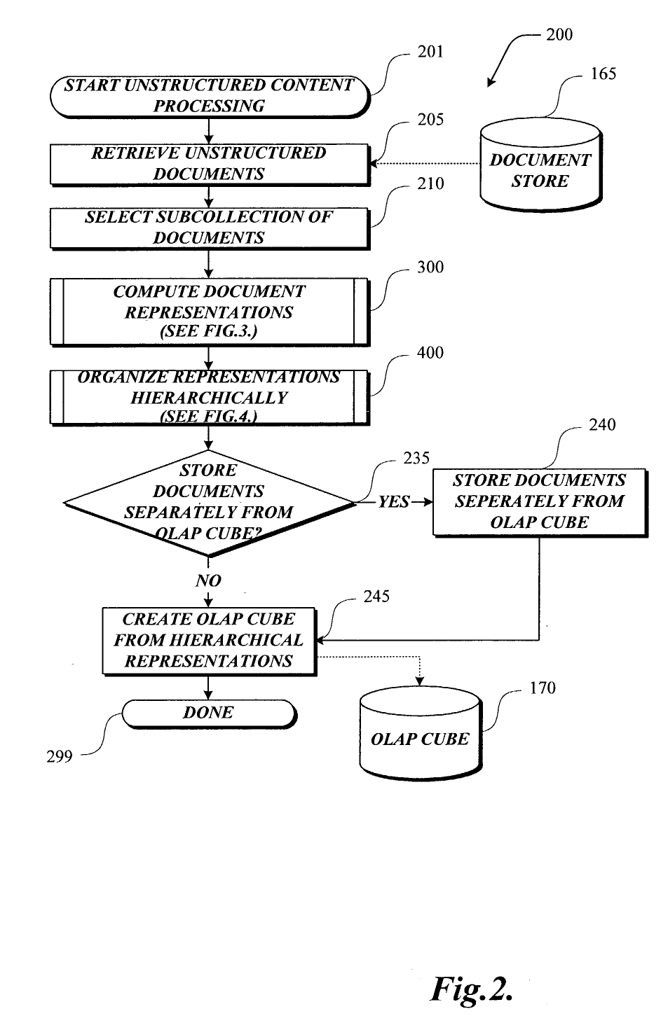

As illustrated in FIG. 1, the computing system 100 of the present invention is used to process unstructured content. The unstructured content processed by the present application may be any type of “document” (e.g., word processing document, e-mail, text file, text record, fax image, scanned image, or any other electronic message or document) that has some measurable features. Features are the parts of a document that express a concept, idea, or other meaningful component. A flow chart illustrating an unstructured content processing routine 200 implemented by the computing system 100 in accordance with one embodiment of the present invention is shown in FIG. 2. The unstructured content processing routine 200 takes unstructured content in the form of unstructured documents (e.g., e-mails, word processing documents, images, faxes, text files, Web pages, etc.) and processes it to form data that can be stored in an OLAP cube 170 to which OLAP tools are available for analysis. The unstructured content processing routine 200 begins in block 201, and proceeds to block 205 where unstructured documents are retrieved from a document store 165.

Next, a subcollection of documents is selected, in block 210, representing the starting point for further dimensional organization. The subcollection should be specific to the dimension of interest. The subcollection can be any subset of documents from the collection, including the whole of the collection. For example, if the collection of documents is a number of call center notes, and the view of the data and the dimension representations is “missing parts,” then the subcollection of documents used as a starting point for the dimension may be all documents in the original call center collection that refer to missing parts. This subcollection can be generated in a number of ways, including, but not limited to key word queries, pre-trained categorization or routing, or manual selection.

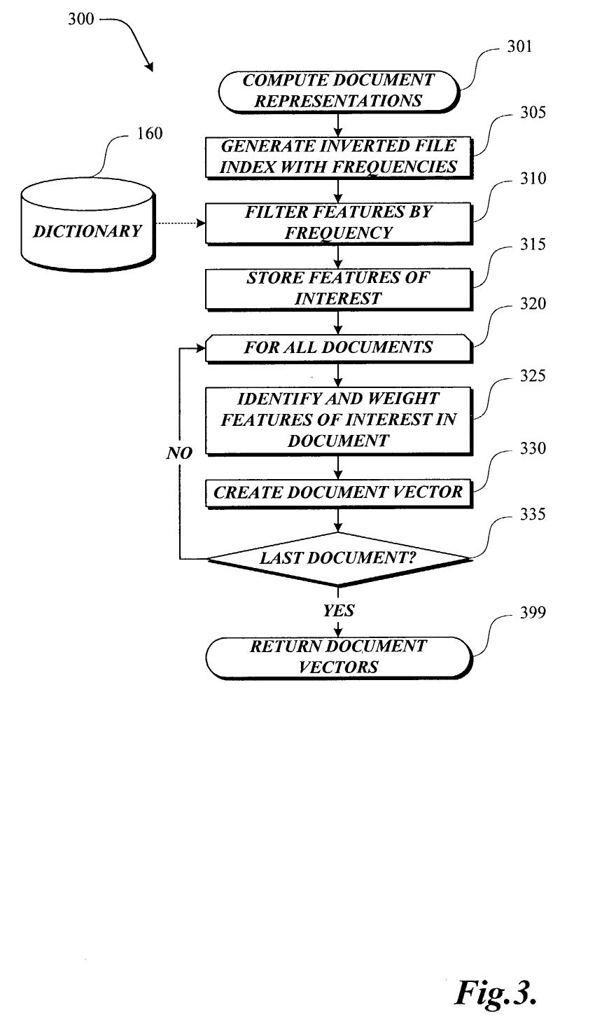

Next, in subroutine block 300, document representations are computed for each of the retrieved selected documents. Document representations are meaningful characterizations that make all documents in a collection comparable. As will be described in more detail below, the document representations are used to organize the unstructured documents into automatically generated hierarchies, as an element of an OLAP dimension. Accordingly, many different document representations may be used. One of ordinary skill in the art will appreciate that any type of document representation, whether it is word counts, key word counts, document vectors, attribute scores, or any other type of document representation may be used, so long as it provides a way of categorizing or representing a document as a quantifiable value or structure. The representation used when implementing subroutine 300 may depend on the type of information desired. For example, any statistical measure, such as, but not limited to, mean, median, mode, maximum, minimum, standard deviation, etc., may be used to measure features of interest (e.g., keywords, punctuation, formatting, headings, etc.) in each document. More complex representations may involve a more complex determination. In the embodiment of the present invention described in more detail below, document vectors are used as the document representation, however, this is not intended to be a limited example. Subroutine 300 is described in greater detail with regard to FIG. 3 below.

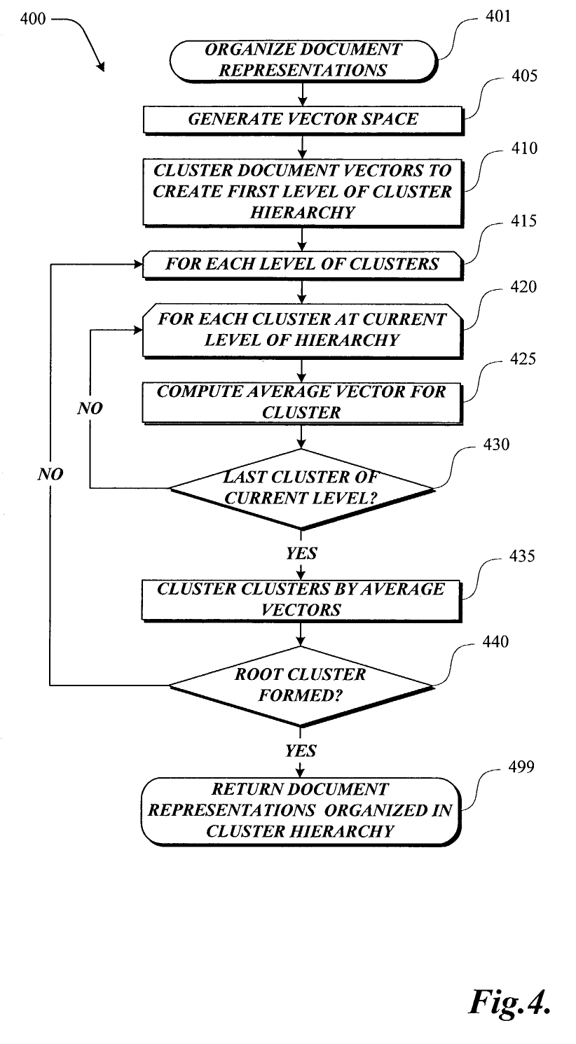

Once the document representations (e.g., document vectors) are computed and subroutine 300 returns, routine 200 continues to subroutine block 400 where the documents are organized in a hierarchical manner using the document representations computed in block 300 (e.g., in a treelike structure) to preserve their similarity together, such that similar documents will get grouped together in the hierarchy. The hierarchy is then used to populate the OLAP cube 170. In one embodiment, the hierarchical manner is a hierarchical clustering of document representations. However, those skilled in the art will appreciate that the document representations may be stored hierarchically in other manners as well, e.g., a binary tree of unclustered document representations, without departing from the spirit and scope of the present invention. Subroutine 400 for organizing documents in a hierarchy is described in greater detail with regard to FIG. 4 below.

Once the documents have been organized in a hierarchical clustering subroutine 400, routine 200 continues to decision block 235 where a determination is made whether to store the documents in addition to the hierarchy to be added to the OLAP cube 170. It may be desirable to store the documents separately because it allows a query to drill down to a separate document and examine it for more information instead of only a document representation. Additionally, storing the documents separately allows for other types of analysis, including keyword searching, that may further validate OLAP processing by finding similar features in the documents. If the documents are to be stored separately, the processing continues to block 240 where the documents are stored in a document store 165. References to the documents are created that are stored in the hierarchy used to populate the cube 170. Whether or not the documents are not stored separately, processing continues to block 245 where an OLAP cube 170 is populated with the references to the hierarchically organized document representations. Processing then ends at block 299.

As noted above, once the structured data from the unstructured documents is stored in the OLAP cube 170, OLAP tools may be applied to the structured data. For example, drilling down to more specific information (including to an actual document if it has been stored separately) or rolling up similar concepts. For example, rolling up “bottled water” goes to “bottled drink,” or perhaps to “water containers,” depending on where it is in a hierarchy. Potentially some OLAP systems would even allow for rolling up to both bottled drinks and water containers. Other OLAP operations that will be familiar to those skilled in the art and made possible by the present invention include, but are not limited to “slicing” (viewing a subset of a cube), “rotating” (changing dimensional orientation of a page), “scoping” (restricting view to specific subset), etc.

Now that the overall content processing routine has been described, its subroutines will be discussed in more detail. As already mentioned above, FIG. 3 illustrates a document representation subroutine 300 for computing document vectors for a corpus of unstructured documents. Subroutine 300 begins at block 301 and proceeds to block 305 where an inverted file index with frequencies of features of interest is generated (e.g., a list of features of interest, in which documents they occur, and how often they occur in a corpus). Next, in block 310, the features are filtered by frequency such that features above an upper threshold and/or below a lower threshold are removed from consideration to increase both the relevance of additional features and the efficiency of processing the documents as high frequency features of the corpus are less likely to provide meaningful distinctions between documents. Similarly low frequency features may not distinguish between documents to a degree that is statistically significant. The frequency thresholds may arbitrarily be set to eliminate only those features that are too common or uncommon to allow for meaningful distinctions between documents. Such removed features are known in the art as “function words.” This process of filtering may be assisted by the use of a dictionary 160 that would be used to normalize distinct words into a common feature. For example, if automobiles were one of the features of interest, then the dictionary may be used to group terms (e.g., synonyms such as car, auto, sedan, etc.) with the features of interest (e.g., automobile). The dictionary may contain word and non-word features (e.g., formatting, grammar, and/or stylistic features), thus allowing for normalizing by eliminating “stop words” (e.g., “the”, “and”, “a”, “an”, “is”, etc.), function words (overly common or uncommon words), and eliminating case sensitivity, thereby reducing the number of features and increasing efficiency.

Once the features are filtered, the remaining features of interest are stored. Next, in block 320 a loop is started for processing each document. In block 325, all features in that particular document are identified and weighted with reference to the inverted file index and the frequency the feature appears in each document. For example, just because a document has a desired feature, the feature may not distinguish it over other documents. Assume that one desired feature occurs highly frequently in the corpus of documents. Will this feature assist in distinguishing each document from other documents in the corpus? Not very efficiently. It will take many of these high frequency features to distinguish any meaningful difference between documents having the common feature. However, a feature that is uncommon in the corpus, but common in a particular document probably does distinguish that document from others in the corpus. Accordingly, these features that provide the most distinction between documents will also be weighted more, as they best characterize the documents relating to other documents in the corpus.

The following example illustrates the creation of a vector representation for three example documents from a fictitious call center log, shown in Table 1.

TABLE 1

| | |
|---|---|
| Document 1 | “The customer called, the second call this week, asking to |
| | speak with a supervisor.” |
| Document 2 | “Customer complained that the remote was missing.” |
| Document 3 | “This was the second call by the customer concerning her |
| | dented speakers.” |

To create a table of word frequencies per document, a feature store is accessed to determine the features in the document that are also found in the feature store. When this lookup is done, each document becomes a row in a table, which is mostly sparse since the number of unique words found in a document is usually much smaller than the number of possible words. Such a table is shown in Table 2.

TABLE 2

| | Features | | | |
|---|---|---|---|---|
| Documents | ask | call | complain | customer |
| D1 | 0 | 2 | 0 | 1 |
| D2 | 0 | 0 | 1 | 1 |
| D3 | 0 | 1 | 0 | 1 |

The word frequencies represented in this table should then be converted to weights that reflect the relative importance of each of these words in each of these documents. When a feature in the feature store is found in a document, a weight is determined for that feature in that particular document. Feature weighting can be performed in a number of ways, but the weighting approach in this example is based on three primary features: The frequency of the feature in the document, the number of documents in the collection that contain the feature, and the number of documents in the collection. A non-limiting example of one possible equation for feature weighting is represented by the following:

FeatureWeightᵢ=(1+log(F_{i j})) log(C/Dᵢ)

with

C=the number of documents in the collection

F_{i j}=the frequency of feature i in document j

Dᵢ=the number of documents in the collection that contain the feature i

Therefore a table showing the weights of our example documents might look like those shown in Table 3:

TABLE 3

| | Features | | | |
|---|---|---|---|---|
| Documents | ask | call | complain | customer |
| D1 | 0 | 0.53 | 0 | 0.04 |
| D2 | 0 | 0 | 0.16 | 0.04 |
| D3 | 0 | 0.21 | 0 | 0.04 |

Once weights are determined, it is possible to create a document vector illustrating how the features of interest characterize the document in block 330. A document vector is composed of a “direction” and a magnitude. The direction is determined from the features of interest. The direction of the vector is directly determined by relative magnitude of the feature values. In two dimensional space, a line drawn from the origin (e.g., point 0,0 on a graph) to any other point determines the direction of the vector. In the four dimensional space described in table 3, the direction is determined in an analogous manner, but in four dimensions. However, in some embodiments of the present invention, only the direction of the document vector is used, and the magnitude is normalized such that all document vectors are considered to be of uniform range of magnitude. Once the document vector for the given document has been created, processing returns to block 320 until the last document has been processed as determined in decision block 335 and a document vector representing each document has been created. Then the routine 300 continues to block 399 where the document vectors for all the documents are returned to the content processing routine 200 so that they may be used later to hierarchically organize the documents.

While in the embodiment of the present invention described above, document vectors are used as the appropriate document representation for the unstructured content, there are other methods that may be used to construct document vectors and many other types of document representations in addition to document vectors that may be used. For example, a simple representation of the content may be derived from a single feature value, or from the attribute scoring methods of copending patent application No. ______, filed concurrently herewith on ______, and entitled “Attribute Scoring for Unstructured Content” (Attorney Docket number IRES-1-19355), which is hereby incorporated by reference, may also be used to create meaningful representations for unstructured documents without departing from the spirit and scope of the present invention.

Returning to FIG. 2, once the document representations, e.g., document vectors have been computed, the documents are then organized hierarchically in a block 400. There are a number of different ways to organize the documents. If, as is shown in subroutine 300, the documents are represented by document vectors, the organization may take place in a vector space. The vector space is the collection of features and their associated index and is automatically created as part of creating document vectors. For example, from TABLE 3 above, the vector space is defined by four components, with the first component being the component represented by the “ask” feature, the second component being the component represented by the “call” feature, the third component being the component represented by the “complain” feature, and the fourth component being the component represented by the “customer” feature. All documents that are represented in this vector space must contain the same count and order of components or features. Accordingly, the documents may be grouped by “clustering” similar documents together based on the values of their respective document vectors. Once all the documents are clustered, then the clusters themselves can be clustered as being similar to each other. The result is a hierarchy of document clusters providing a structured form that can ultimately be stored in an OLAP cube 170.

FIG. 4 illustrates a subroutine for providing such a hierarchical clustering of vector-represented documents (e.g., an OLAP dimension). Subroutine 400 begins at block 401 and proceeds to block 405 where a vector space for the document representations is generated. Next, in block 410, similar documents are clustered together by vector to produce a first level of document clusters. Documents are clustered together based upon the similarities of their respective document vectors. For example, the six documents in TABLE 4 can be clustered using a Cosine distance measure that is indifferent to the absolute measure of any features. TABLE 5 illustrates the cosine distance between each pair of documents, with the cosine measure represented by the equation:

cos(v1,v2)=Σ_{for all i}v1ᵢ v2ᵢ/(sqrt(Σ_{for all i}V1ᵢ²)sqrt(Σ_{for all i}v2ᵢ²))

Several parameters would typically be used to determine the number of groups and the number of documents in each group. To continue with the example, documents D1, D2, D3, and D6 are placed into group 1 due to the high similarity captured in the cosine distance matrix (higher the score, the more similar the documents); similarly, documents D4, D7, and D8 are placed in a group 2, and D5 in a group 3 all by itself, since it is not near any other document as measured by the cosine distance. A vector is then created for each group by computing the average vector for all documents in each group. For example, the average vector for group one, comprised of documents D1, D2, D3, and D6 is computed as follows:

“ask” component value=(0.0+0.0+0.0+0.0)/4=0.0

“call” component value=(0.5+0.0+0.2+0.3)/4=0.25

“complain” component value=(0.0+0.1+0.0+0.0)/4=0.025

“customer” component value=(0.4+0.4+0.4+0.4)/4=0.4

The group vector then is {0.0, 0.25, 0.025, 0.4}. When the three group vectors have been computed, they are grouped in the same manner as the document vectors to produce a higher layer in the hierarchy.

TABLE 4

| | Features | | | |
|---|---|---|---|---|
| Documents | ask | call | complain | customer |
| D1 | 0.0 | 0.5 | 0.0 | 0.4 |
| D2 | 0.0 | 0.0 | 0.1 | 0.4 |
| D3 | 0.0 | 0.2 | 0.0 | 0.4 |
| D4 | 0.1 | 0.0 | 0.5 | 0.0 |
| D5 | 0.4 | 0.0 | 0.0 | 0.1 |
| D6 | 0.0 | 0.3 | 0.0 | 0.4 |
| D7 | 0.0 | 0.2 | 0.8 | 0.0 |
| D8 | 0.1 | 0.0 | 0.3 | 0.0 |

TABLE 5

| | D1 | D2 | D3 | D4 | D5 | D6 | D7 | D8 |
|---|---|---|---|---|---|---|---|---|
| D1 | — | .61 | .90 | .00 | .15 | .97 | .19 | .00 |
| D2 | .61 | — | .89 | .24 | .24 | .78 | .24 | .23 |
| D3 | .90 | .89 | — | .00 | .22 | .98 | .11 | .00 |
| D4 | .00 | .24 | .00 | — | .19 | .00 | .96 | .98 |
| D5 | .15 | .24 | .22 | .19 | — | .20 | .00 | .30 |
| D6 | .97 | .78 | .98 | .00 | .20 | — | .39 | .00 |
| D7 | .19 | .24 | .11 | .96 | .00 | .39 | — | .91 |
| D8 | .00 | .23 | .00 | .98 | .30 | .00 | .91 | — |

The first level of clusters may have one or more documents in each of the clusters. Next, in block 415, a loop begins that will continue until a final cluster has been created at a last level that has just a single cluster as a “root” cluster in a hierarchy of clusters. Next, in block 420, an interior loop for each cluster begins in which an average document vector is for each cluster computed in block 425. Once all of the average document vectors for each cluster in a level are computed as determined in block 430, the clusters in that level are grouped according to the average document vector for each cluster to form new clusters for the next level up in the hierarchy in block 435. Next, at block 440, the exterior loop continues until each level of clusters is clustered to ultimately form a root cluster. Once the root cluster has been formed, processing continues to block 499 where the hierarchically organized clusters are returned to the content processing routine 200 so that the hierarchy may be stored in the OLAP cube 170. Once the hierarchy of clusters has been formed, the document representations may be discarded, as the hierarchy, of clusters embodies essentially the same information. The process described for creating a single dimension can be repeated indefinitely to provide multiple dimensions for multi-dimensional analysis.

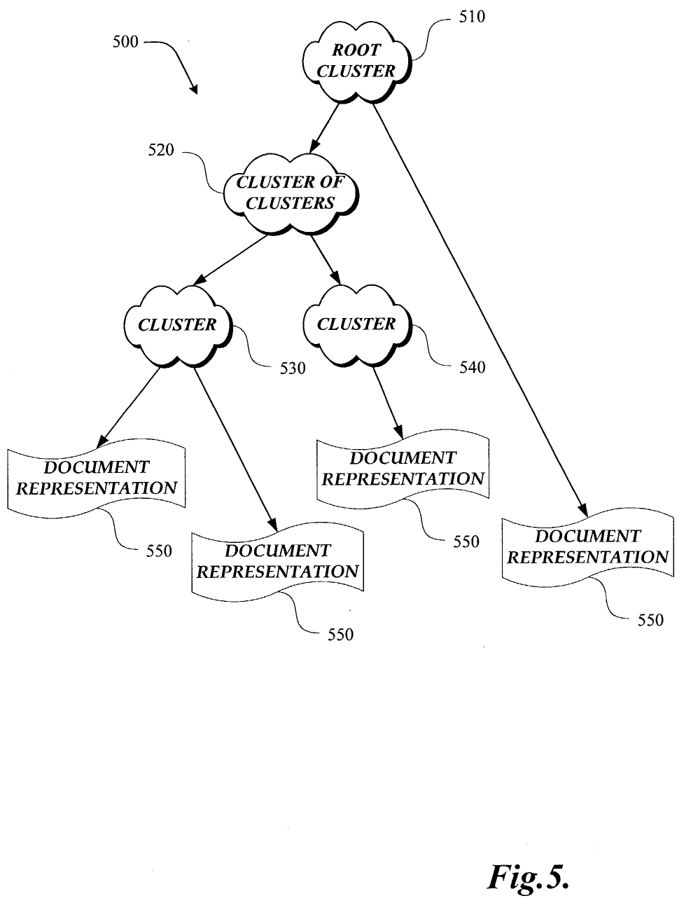

FIG. 5 represents a simplified hierarchy 500 of clusters and documents. Each document 550 is a node off of a cluster 530 or at least off of the root cluster 510. The hierarchy also includes clusters of clusters 520 which are the intermediate levels of clusters in the hierarchy between the root cluster 510 and the lower level clusters 530. The depth (number of levels) of the hierarchy can be varied depending on parameter settings of a clustering algorithm and the particular clustering algorithms used to determine which documents and/or clusters will be grouped together. Such clustering algorithms are known in the art and may be either bottom up (agglomerative), as the one described in this document, or top-down (divisive), which proceeds by iteratively and recursively breaking up a single group of documents (the subcollection) into multiple, hierarchically organized groups. Once the hierarchy 500 is formed it represents the relationships between documents. Accordingly, it is then possible to add the hierarchy 500 to an OLAP cube, such as OLAP cube 170. This enables querying of the OLAP cube 170 on structured data from the documents in the hierarchy. It is the structure of the hierarchy that allows for the OLAP analysis of the otherwise unanalyzable unstructured documents.

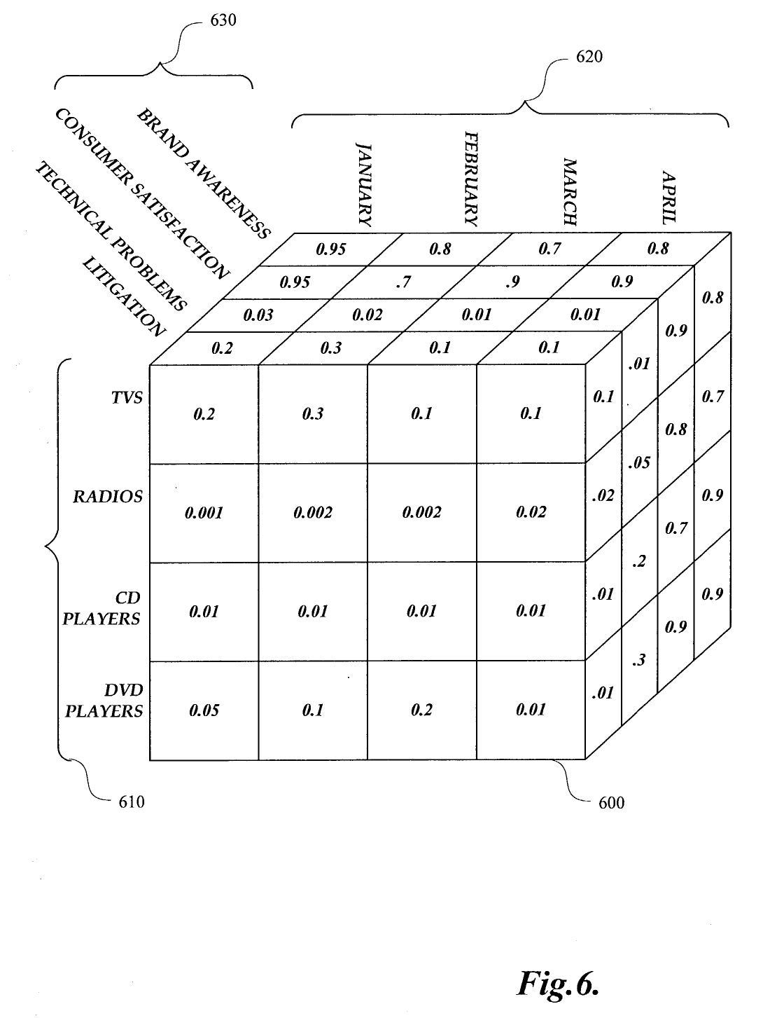

FIG. 6 illustrates an exemplary OLAP data cube 600 with a number of attribute measures of interest 630. Attribute measures quantify some value of interest in the particular document collection. For traditional OLAP business analysis, an example would be sales or revenue measured in dollars. In the example cube 600 the attribute measures of interest 630 are: brand awareness, consumer satisfaction, technical problems and litigation. Values for the measures can be computed in a number of ways. In one embodiment of the present invention, measures are computed by examining numerous features associated with the measures and quantifying the importance and degree of those features in each document, thereby transforming unstructured documents into quantities that can be manipulated by standard OLAP operators. The attribute scoring methods of copending patent application entitled “Attribute Scoring for Unstructured Content,” which was incorporated by reference above, are exemplary methods used to create meaningful attribute measures. These attribute measures are stored as a collection of database records, known as a “fact table” in the art, indicating document ID, attribute ID, and the value of the measure.

The OLAP cube 600 has been populated using the content processing routine 200 described above. In the exemplary simplified OLAP data cube 600 shown in FIG. 6 there are four subject headings: TVs, radios, CD players, and DVD players; and four time headings 620: January, February, March, and April. As can be seen, corresponding to each of these subject and time headings there are measures of litigation, technical problems, consumer satisfaction, and brand awareness attributes. Each of these measures has been assigned a value in one of the corresponding intersections of subject and time. For example, under technical problems for CD players in March, there is a value of 0.01 indicating a relatively lower instance of technical problems than that found for CD players in February, which had a value of 0.02. While FIG. 6 is a simplified illustration, those of ordinary skill in the art will appreciate that OLAP data cubes will usually have more than two dimensions (subject matter and time), and will usually contain many more headings under each of these delimiters. However, FIG. 6 is meant merely for illustrative purposes to illustrate the present invention.

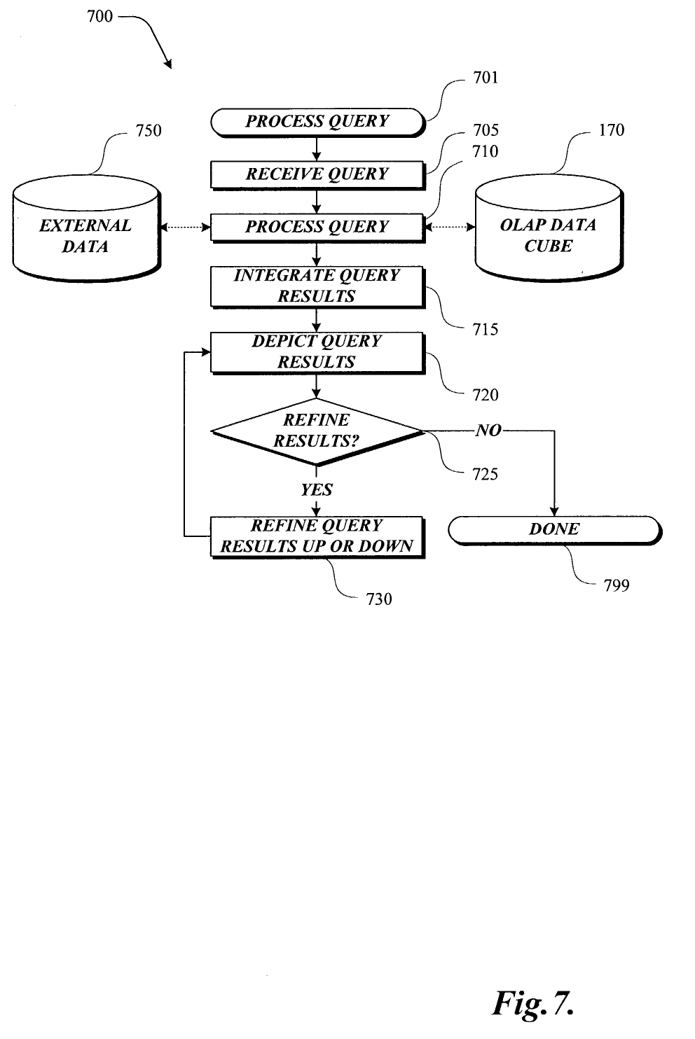

Once structured data from the document has been stored in an OLAP cube as described above, it may be retrieved much more easily than otherwise possible. By way of illustration, a simplified query routine 700 has been provided in FIG. 7 to illustrate the retrieval of information in an OLAP data cube 170 in accordance with the present invention. Exemplary query processing routine 700 begins at block 701 and proceeds to block 705 where a query is received. Next, in block 710, the query is processed to retrieve information from the OLAP data cube and, optionally, may include an external data source 750, such as the filtered documents that may be stored separately, for providing additional information to the results of the OLAP data cube query. For example, if the query on the OLAP data cube is related to customer satisfaction for televisions marketed by a company in January of a particular year, the external data source may provide sales figures for that particular time period as well to provide an additional correlation. As the sales figures would normally be stored in a structured format, it would be unnecessary to integrate such figures into the OLAP data cubes, as it would be more efficient to store those under the conventional relational database systems. Assuming that such an external data source 750 is used in block 710, then in block 715, the query results are integrated such that the external data information and the OLAP data cube results are combined. Next, in block 720, the query results are depicted to a requesting user. Such depiction may be on a single machine or may also be over a network to other devices. In decision block 725 a determination is made whether to refine the results depicted from the query. If so, then processing proceeds to block 730, otherwise processing ends at block 799. In block 730 the query results are refined by using conventional “drill down” or “roll up” operations on the OLAP query results to get more detailed information on the results or more generalized information respectively. After refining the results, processing loops back to depict the new results in block 720. Routine 700 then ends at block 799.

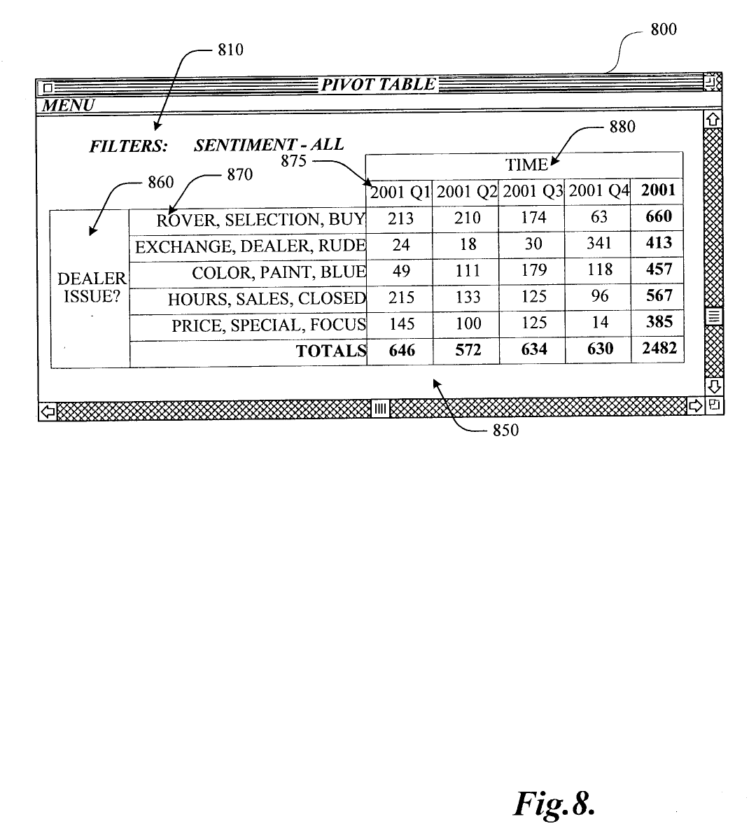

FIG. 8 illustrates an exemplary screenshot 800 of query results such as might be seen in block 720 of routine 700 where query results are illustrated to the user querying an OLAP data cube in accordance with the present invention.

The query results are shown as a pivot table 850. A pivot table is an interface element used to explore multi-dimensional content. It operates as a multi-way cross tab that presents one or more dimensional breakdowns 870, 875, and the intersections between them. The intersections between dimensional breakdowns are represented with a numerical measure that characterizes that intersection, and the totals representing an intersection of the dimensions 860, 880. In the pivot table 800 shown in FIG. 8, one dimension name 860 is related to sentiment (note filter setting of “SENTIMENT-ALL” 810) and dealer issues, while the other dimension relates to time 880. FIG. 8 merely represents one exemplary presentation method of the results of an OLAP query, and should be considered to limit the potential presentations of the results of an OLAP query. Other exemplary presentation methods may include graphs, multidimensional objects, textual descriptions or the like.

While the preferred embodiment of the invention has been illustrated and described, it will be appreciated that various changes can be made therein without departing from the spirit and scope of the invention. For example, instead of filtering features of interest during other routines, the corpus of documents may be preprocessed or pre-filtered so as to normalize the words in the corpus to increase the speed and/or accuracy of the other routines in the present invention. Such preprocessing may comprise removing the case variations of words, eliminating stop words, and potentially eliminating function words.

The embodiments of the invention in which an exclusive property or privilege is claimed are defined as follows:

1. A method for processing unstructured documents to populate an OLAP data structure, the method comprising:
selecting a plurality of unstructured documents from a corpus of unstructured documents;
computing a document representation for each selected document;
organizing said selected documents into a hierarchy of document clusters based on said document representations;
populating the OLAP data structure using said hierarchy of document clusters, and;
computing a document measure for each selected document.

2. The method of claim 1, wherein said document representation is a document vector.

3. The method of claim 1, wherein said document representation for an selected document is computed by:
filtering features of interest in said selected documents;
weighting said filtered features of interest; and
determining a value for said document representation based on said weighted features of interest.

4. The method of claim 3, wherein filtering features of interest in said selected documents comprises:
generating an inverted file index for said selected documents, wherein said inverted file index identifies each feature of interest, the selected document or documents in which each feature of interest occurs, and the frequency in which each feature of interest occurs in said selected documents; and
removing features of interest based on the frequency in which said features of interest occur in said selected documents.

5. The method of claim 4, wherein filtering features of interest further comprises normalizing related features of interest into a common feature of interest.

6. The method of claim 4, wherein removing features of interest based on the frequency in which said features of interest occur in said selected documents comprises removing features of interest that occur at a frequency above a predetermined threshold.

7. The method of claim 4, wherein removing features of interest based on the frequency at which said features of interest occur in said selected documents comprises removing features of interest that occur at a frequency below a predetermined threshold.

8. The method of claim 4, wherein at least some of said features of interest are word features.

9. The method of claim 8, wherein said word features removed are function words.

10. The method of claim 8, wherein said word features removed are stop words.

11. The method of claim 8, wherein word features removed are case variations of the same word.

12. The method of claim 4, wherein at least some of said features of interest are non-word features.

13. The method of claim 3, wherein weighting said filtered features of interest comprises assigning a greater weight to those features of interest that occur at a higher frequency within a particular document.

14. The method of claim 2, wherein the direction and magnitude of said document vector are determined by cosine measure.

15. The method of claim 1, wherein said document measure is an attribute score.

16. The method of claim 1, wherein organizing said selected documents into a hierarchy of document clusters comprises:
(a) forming a first prior level of document clusters based on similarities between the respective document measures of said selected documents;
(b) computing an average document measure for each document cluster in the prior level of document clusters, and
(c) forming a next level of document clusters based on similarities between the respective average document measures of the document clusters in the prior level of document clusters.

17. The method of claim 16 further comprising repeating (b) and (c) until the next level of document clusters forms a root document cluster.

18. The method of claim 16, wherein each document cluster in the first prior level of document clusters is formed by grouping together selected documents with similar document measures.

19. The method of claim 16, wherein each document cluster in the next level of document clusters is formed by grouping together document clusters from the prior level with similar average document measures.

20. The method of claim 1 further comprising filtering said selected documents.

21. The method of claim 1 further comprising applying an OLAP tool to the OLAP data structure.

22. The method of claim 21, wherein said OLAP tool is a drill-down tool.

23. The method of claim 21, wherein said OLAP tool is a roll-up tool.

24. The method of claim 1 further comprising obtaining information from selected documents by querying the OLAP data structure.

25. The method of claim 24, wherein said queried information is depicted in a pivot table.

26. The method of claim 24, wherein said queried information is depicted in a chart.

27. A computer readable medium containing computer executable instructions for processing unstructured documents to populate an OLAP data structure, the computer readable medium comprising:
a selection module for:
selecting a plurality of unstructured documents from a corpus of unstructured documents;
a representation module for:
computing a document representation for each selected document; and
an organization module for:
organizing said selected documents into a hierarchy of document clusters based on said document representations;
populating the OLAP data structure using said hierarchy of document clusters, and;
computing a document measure for each selected document.

28. The computer readable medium of claim 27, wherein said document representation is a document vector.

29. The computer readable medium of claim 27, wherein representation module further comprises instructions for:
filtering features of interest in said selected documents;
weighting said filtered features of interest; and
determining a value for said document representation based on said weighted features of interest.

30. The computer readable medium of claim 29, wherein filtering features of interest in said selected documents comprises:
generating an inverted file index for said selected documents, wherein said inverted file index identifies each feature of interest, the selected document or documents in which each feature of interest occurs, and the frequency in which each feature of interest occurs in said selected documents; and
removing features of interest based on the frequency in which said features of interest occur in said selected documents.

31. The computer readable medium of claim 30, wherein filtering features of interest further comprises normalizing related features of interest into a common feature of interest.

32. The computer readable medium of claim 30, wherein removing features of interest based on the frequency in which said features of interest occur in said selected documents comprises removing features of interest that occur at a frequency above a predetermined threshold.

33. The computer readable medium of claim 30, wherein removing features of interest based on the frequency at which said features of interest occur in said selected documents comprises removing features of interest that occur at a frequency below a predetermined threshold.

34. The computer readable medium of claim 30, wherein at least some of said features of interest are word features.

35. The computer readable medium of claim 34, wherein said word features removed are function words.

36. The computer readable medium of claim 34, wherein said word features removed are stop words.

37. The computer readable medium of claim 34, wherein word features removed are case variations of the same word.

38. The computer readable medium of claim 30, wherein at least some of said features of interest are non-word features.

39. The computer readable medium of claim 29, wherein weighting said filtered features of interest comprises assigning a greater weight to those features of interest that occur at a higher frequency within a particular document.

40. The computer readable medium of claim 28, wherein the direction and magnitude of said document vector are determined by cosine measure.

41. The computer readable medium of claim 27, wherein said document measure is an attribute score.

42. The computer readable medium of claim 27, wherein the organization module organizes documents into hierarchies by:
(a) forming a first prior level of document clusters based on similarities between the respective document measures of said selected documents;
(b) computing an average document measure for each document cluster in the prior level of document clusters, and
(c) forming a next level of document clusters based on similarities between the respective average document measures of the document clusters in the prior level of document clusters.

43. The computer readable medium of claim 42 further comprising repeating (b) and (c) until the next level of document clusters forms a root document cluster.

44. The computer readable medium of claim 42, wherein each document cluster in the first prior level of document clusters is formed by grouping together selected documents with similar document measures.

45. The computer readable medium of claim 42, wherein each document cluster in the next level of document clusters is formed by grouping together document clusters from the prior level with similar average document measures.

46. The computer readable medium of claim 27 wherein the selection module further comprises filtering said selected documents.

47. The computer readable medium of claim 27 further comprising a query module for applying an OLAP tool to the OLAP data structure.

48. The computer readable medium of claim 47, wherein said OLAP tool is a drill-down tool.

49. The computer readable medium of claim 47, wherein said OLAP tool is a roll-up tool.

50. The computer readable medium of claim 27 further comprising a query module for obtaining information from selected documents by querying the OLAP data structure.

51. The computer readable medium of claim 50, wherein said queried information is depicted in a pivot table.

52. The computer readable medium of claim 50, wherein said queried information is depicted in a chart.

53. A computing apparatus for processing unstructured documents to populate an OLAP data structure, the computing apparatus operative to:
select a plurality of unstructured documents from a corpus of unstructured documents;
compute a document representation for each selected document;
organize said selected documents into a hierarchy of document clusters based on said document representations;
populate the OLAP data structure using said hierarchy of document clusters, and;
compute a document measure for each selected document.

54. The computing apparatus of claim 53, wherein said document representation is a document vector.

55. The computing apparatus of claim 53, wherein said document representation for an selected document is computed by:
filtering features of interest in said selected documents;
weighting said filtered features of interest; and
determining a value for said document representation based on said weighted features of interest.

56. The computing apparatus of claim 55 wherein filtering features of interest in said selected documents comprises:
generating an inverted file index for said selected documents, wherein said inverted file index identifies each feature of interest, the selected document or documents in which each feature of interest occurs, and the frequency in which each feature of interest occurs in said selected documents; and
removing features of interest based on the frequency in which said features of interest occur in said selected documents.

57. The computing apparatus of claim 56, wherein filtering features of interest further comprises normalizing related features of interest into a common feature of interest.

58. The computing apparatus of claim 56, wherein removing features of interest based on the frequency in which said features of interest occur in said selected documents comprises removing features of interest that occur at a frequency above a predetermined threshold.

59. The computing apparatus of claim 56, wherein removing features of interest based on the frequency at which said features of interest occur in said selected documents comprises removing features of interest that occur at a frequency below a predetermined threshold.

60. The computing apparatus of claim 56, wherein at least some of said features of interest are word features.

61. The computing apparatus of claim 60, wherein said word features removed are function words.

62. The computing apparatus of claim 60, wherein said word features removed are stop words.

63. The computing apparatus of claim 60, wherein word features removed are case variations of the same word.

64. The computing apparatus of claim 56, wherein at least some of said features of interest are non-word features.

65. The computing apparatus of claim 55, wherein weighting said filtered features of interest comprises assigning a greater weight to those features of interest that occur at a higher frequency within a particular document.

66. The computing apparatus of claim 54, wherein the direction and magnitude of said document vector are determined by cosine measure.

67. The computing apparatus of claim 53, wherein said document measure is an attribute score.

68. The computing apparatus of claim 53, wherein organizing said selected documents into a hierarchy of document clusters comprises:
(a) forming a first prior level of document clusters based on similarities between the respective document measures of said selected documents;
(b) computing an average document measure for each document cluster in the prior level of document clusters, and
(c) forming a next level of document clusters based on similarities between the respective average document measures of the document clusters in the prior level of document clusters.

69. The computing apparatus of claim 68 further operative to repeat (b) and (c) until the next level of document clusters forms a root document cluster.

70. The computing apparatus of claim 68, wherein each document cluster in the first prior level of document clusters is formed by grouping together selected documents with similar document measures.

71. The computing apparatus of claim 68, wherein each document cluster in the next level of document clusters is formed by grouping together document clusters from the prior level with similar average document measures.

72. The computing apparatus of claim 53 further operative to filter said selected documents.

73. The computing apparatus of claim 53 further operative to apply an OLAP tool to the OLAP data structure.

74. The computing apparatus of claim 73, wherein said OLAP tool is a drill-down tool.

75. The computing apparatus of claim 73, wherein said OLAP tool is a roll-up tool.

76. The computing apparatus of claim 53 further operative to obtain information from selected documents by querying the OLAP data structure.

77. The computing apparatus of claim 76, wherein said queried information is depicted in a pivot table.

78. The computing apparatus of claim 76, wherein said queried information is depicted in a chart.
